(19) United States
(12) Patent Application Publication
(10) Pub. No.: US 2019/0299204 A1
(43) Pub. Date: Oct. 3, 2019

(54) CAROUSEL ISOLATOR

(71) Applicant: Stephan HAMMELBACHER, Reichersbeuern (DE)

(72) Inventor: Stephan HAMMELBACHER, Reichersbeuern (DE)

(21) Appl. No.: 16/315,988

(22) PCT Filed: Jul. 7, 2017
(86) PCT No.: PCT/EP2017/067113

§ 371 Date: Jan. 7, 2019

(30) Foreign Application Priority Data
Jul. 8, 2016 (DE) 10 2016 112 549.0

(51) Int. Cl. B01L 1/02; A01K 1/03; A01K 1/035; A01K 1/02; A01G 9/02; B01L 3/00

(52) U.S. Cl. CPC B01L 1/025; A01K 1/031; A01K 1/035; B01L 2200/087; A01G 9/023; B01L 3/508; A01K 1/0245

(57) ABSTRACT

Work on or in an isolator assembly is made difficult by the gloved intervention points also with regard to the movement space. Any facilitation can contribute to a lower physical effort and to a lower error quota. According to a further advantageous embodiment of the isolator assembly, this can therefore have operating devices for operating a rack and/or for operating the control device of the isolator assembly for users, in particular by keypad at a gloved intervention point and/or via voice recognition and/or by foot pedals. Details relating to these devices can be obtained from the application WO 2011/124 209 A, the relevant content of which is also made the content of the present application.

The invention relates to an isolator assembly for producing an maintaining a sterile environment even under working conditions, in particular for plant cultivation, for animal research or for preparing medicaments. This isolator assembly is used to accommodate a plurality of containers, which each contain at least one object. The object should be held and optionally manipulated for research purposes under conditions which are as clearly defined as possible. Used for this purpose is a worktop on which at least two containers are placed and work can be performed or processes can be carried out on these containers or the contents thereof. Also the defined conditions should not be adversely affected thereby. For this purpose the isolator assembly has an air lock device in order to be able to load material into the isolator and unload material from the isolator without adversely affecting the defined conditions. The operation of the isolator should furthermore meet the ergonomic requirements of an operator.

An isolator assembly for accommodating and processing a plurality of containers is disclosed in U.S. Pat. No. 3,302,615 A. The isolator assembly has a plurality of movable rack assemblies for accommodating the containers, which are each assigned a worktop. A plurality of rack assemblies have a common air lock device and therefore require a certain space requirement.

It is therefore the object of the invention to provide an isolator assembly which fulfils ergonomic requirements of a user with a smallest possible space requirement.

This object is fulfilled by an isolator assembly, in particular for plant cultivation or animal research or preparation of medicaments comprising the following components:
a cylindrical rack which has a vertical axis as a result of its geometrical shape,
a plurality of containers each for accommodating at least one object as the contents thereof, which are arranged circumferentially in the rack and are accessible or can be operated in a radial direction,
a worktop in the immediate spatial vicinity of the rack, i.e. at a maximum distance of an arms' length,
a tent or a shell for the joint sterile airtight shielding of the rack and at the same time the worktop with respect to the surrounding area,
gloved intervention points in the tent for operating and for processing the containers and the contents thereof between the rack and the worktop or on the worktop,
an air lock device in the tent for introducing sterile material into the tent and for removing contaminated material from the tent, and
a device for repositioning the rack relative to the worktop in an axial direction and in a vertical direction, i.e. along its vertical axis and in a rotational direction, i.e. around its vertical axis.

According to the invention, the isolator assembly therefore has a rack which in principle has a circular cylindrical outer shape with a plurality of tiers arranged horizontally above one another, which can accommodate substantially circular-sector-shaped containers around its vertical axis. With planar instead of curved front sides of the containers, the rack can actually have a polygonal outline, with six containers per tier for example a hexagonal outline. The containers can be pushed into the rack in a radial direction and removed in the opposite direction. For example, DE 1 507 065 A shows the fundamental structure of such a circular cylindrical rack.

For processing the containers and/or their content, the isolator assembly has a worktop which is not further distant from the rack than approximately an arm's length. Thus, a user standing in front of the worktop can remove a container from the rack over the worktop and process this as intended. In order that the user can stand or optionally sit comfortably in front of the worktop, the isolator assembly can leave a foot region free under the worktop, the area of which substantially corresponds to the horizontal extension of the worktop.

Both the worktop and also the rack are jointly enclosed by a tent or by a shell, which forms a gastight and therefore sterile shielding with respect to the surrounding area. The terms tent and shell should be understood functionally and include both a flexible or deformable shielding and also a shielding made of a stiff material as well as combinations of stiff and flexible sections. The material of the tent, in addition to its property as flexible or rigid, can also be selected according to further criteria such as the best possible transparency and its durability with respect to the sterilizing media used. The transparency is used for a good permeability to light and visual transparency so that the rack itself does not require its own light source and can be examined free from hindrances through the tent. The durability with respect to the sterilizing media crucially determines the lifetime of the tent. Depending on the requirement and selected sterilizing method, possible materials for the tent can be PVC (polyvinyl chloride), vinyl, polyurethane or acrylic, PSU (polysulphone), PC (polycarbonate) or PEI (polyetherimide).

In order that an operator can now manipulate the containers or their content without needing to completely enter into the tent himself, the isolator assembly has gloved intervention points which are arranged over the worktop in such a manner that they allow access to containers in the rack and activities on the worktop.

In order to also allow an exchange of material between the interior of the tent, i.e. substantially between the rack and the shielded surrounding area opposite the rack, the isolator assembly has an air lock device known per se. By this means at least individual containers can be transported through the tent without the defined conditions inside the tent being adversely affected.

Finally the isolator assembly has one or possibly one device in each case for repositioning the rack relative to the worktop and specifically in an axial direction of the rack, i.e. in a vertical direction upwards and downwards and additionally for repositioning in a rotational direction of the rack about the vertical axis, i.e. for rotating the substantially cylindrical rack about its vertical or cylinder axis. The rotation about its cylinder axis relative to the worktop enables accessibility of the rack from the same position of the worktop at each point on the circumference of the rack. By rotating the rack relative to the worktop, fundamentally all the containers of the rack can therefore be reached from the worktop regardless of the position at which they are positioned when viewed in the circumferential direction.

For the rotational relative movement, in principle three embodiments of the isolator assembly can be distinguished:
the rack can be mounted rotatably about its vertical axis and the worktop can be arranged to be stationary,
the worktop can be arranged rotatably about the vertical axis of the rack in a pivotable manner and the rack itself can be arranged to be stationary or
both the rack and also the worktop can be mounted rotatably or pivotably about the vertical axis of the rack and both thus arranged moveably with respect to a stationary counter-bearing.

Each of these three variants has its specific advantages which can be at the forefront in the respective case of application. Thus, the containers of a stationary rack and a pivotable worktop do not undergo any movements which can be advantageous in animal research devices with cages occupied by animals as containers. A stationary worktop with a rotatable rack on the other hand can result in a very compact structure of the isolator assembly, which specifically makes it possible to use the isolator assembly in smaller research facilities for the first time. Both a rotatable rack and also a pivotable worktop can in turn be moved towards one another according to direction and can thus result in a particularly rapid actuation of the isolator assembly through a rapid access to the containers, which can shorten the working sequences inside the isolator assembly.

The vertical relative movement of the rack and the worktop with respect to one another enables a more comprehensive rack in its height extension since its vertical movement relative to the worktop allows accessibility even to high or low-lying containers in the rack despite the restricted scope for movement of a user through the gloved intervention points.

The vertical movement of the rack relative to the worktop can also be configured according to three basic principles in the manner described for the rotation:
the rack can be displaceable vertically with respect to the stationary worktop,
the worktop can be displaceable vertically with respect to the stationary rack and finally
both the rack and also the worktop are displaceable vertically with respect to one another via a stationary counter-bearing.

These designs in principle afford the corresponding advantages as specified for the three possibilities for rotational movement.

Further possible variations are obtained as a result of the fact that the rack can be configured to the fundamentally movable and the worktop fundamentally stationary or conversely. Furthermore, the rack can, for example, be vertically movable but rotationally stationary and the worktop can be configured to be rotationally movable and vertically stationary or conversely. Advantages of the respective embodiments can lie, for example, in operating comfort or in the constructive simplicity of the devices for rotational or translational movement of the rack or the worktop or both. Their selection can in particular be oriented on which movement requirements are to be satisfied and can be configured most favourably under the conditions of a hermetically shielding tent.

In particular, in an embodiment of the isolator assembly with a merely rotatable but vertically stationary rack, on one only vertically movable worktop the isolator assembly can comprise a robot arm for removing the containers from the rack and for placing them on the worktop. The robot arm can be moved vertically in front of the rotatable rack together with the worktop and relieve the user of removing the containers from the rack. The robot arm therefore not only unburdens the users from a physically strenuous activity but the rack can also be designed to be considerably higher since it no longer needs to be designed for a removal of containers by the users with the aid of gloved intervention points, which restrict the user in his possible scope for movement and in particular in his range. Thus, considerably more containers can be accommodated on the same base area, which can contribute to an economical operation of the isolator assembly.

In any case, all the embodiments of the isolator assembly with a cylindrical rack and a worktop which can be moved both rotationally and also translationally in a linear direction of movement with respect to one another have in common that despite compulsory operation via gloved intervention points, they offer an ergonomically favourable accessibility to a plurality of containers in a hermetically shielded tent.

A rotational displacement of the rack with respect to a worktop can be accomplished by muscle force in the case of a suitable smooth-running mounting. Vertically aligned handles on the circumference of the rack can facilitate a rotational movement of the rack by hand, whilst the user pushing off from the ground can enable a pivoting of a pivotably mounted worktop around a stationary rack. A vertical displacement usually requires mechanical assistance of the user as a result of the weight of the rack or the worktop together with shell. This mechanical assistance can, for example, consist in pre-tensioned or in gas-pressure springs or comprise a pedal actuation. According to an advantageous configuration of the invention, the isolator assembly can comprise at least one motor drive for repositioning the rack relative to the worktop. The motor drive fundamentally facilitates the repositioning but can offer constructive challenges in the case of its arrangement inside the tent. The motor drive can therefore preferably be arranged outside the tent. There it offers easier accessibility for maintenance and possible replacement work and eliminates contamination for example due to the abrasion of carbon brushes of an electric motor in the tent. This aspect primarily relates to the motor drive for repositioning the rack insofar as it is arranged largely completely inside the tent, whereas a drive of a worktop—which favourably coincides with a movement of the tent around the rack or up and down on the rack—can advantageously take place from an outer side of the isolator assembly and therefore largely conventionally. The control of the motor or the motors can either be accomplished via servo motors, which include soft-start and soft-stop functions and the complete control logic or via cable laid on terminal strip and a controller connected here with a machine control.

In principle, the rotational repositioning of the rack with respect to the stationary worktop can take place by a rotation of the entire rack. According to an advantageous embodiment of the invention, the rack can comprise individual horizontally running disk-shaped plates on which the containers can be placed. The plates need not be configured as closed-surface but can have grids or supporting frames for rail-guided insertion of the containers. Advantageously, only individual plates can be rotated separately about the vertical axis independently of the rotation of the entire rack. An individual plate can therefore be individually twisted with respect to a stationary rack or with respect to a rotating rack in order to achieve a more rapid access of the user to a desired container. The individual twisting of individual parts saves energy because the entire rack need not be set in motion. In addition, it can accelerate access to a desired container since a smaller inertia must be overcome for the twisting of a plate than for the rotation of the entire rack. A particularly cost-effective variant can therefore be an isolator assembly with an exclusively vertically movable rack, wherein the worktop is arranged to be stationary and its containers can be reached by manual turning of only individual rack plates. Thus, a motor drive of the rotation of the rack and its encapsulation or shielding with respect to the atmosphere inside the tent can be omitted which also favours the maintenance of the isolator assembly by dispensing with maintenance and repair work.

A constructive challenge can in particular be the vertical repositionability of the rack inside the tent. Thus, the vertical movement by means of a toothed rack running in the direction of the vertical axis and a toothed wheel intermeshing therewith can be converted into a rotational movement, whereby the rotational movement can be guided outwards via an axis through the tent. The rotatable axis can be sealed in an airtight manner with respect to the stationary tent relatively reliably in a suitable feed-through. Alternatively, a hydraulic lifting device can be provided which however can require external oil sumps. In addition, a possibly leaky hydraulics constitutes a high risk in the isolator assembly.

According to a further advantageous embodiment of the invention, the rack can be vertically adjustable by means of a scissors elevating drive, whose drive can also be reliably sealed through a rotational or translational movement and its feed-through through the tent. With suitable dimensioning of the scissors of the elevating drive, said drive can have a suitably flat structure in order to occupy as little space as possible underneath the rack.

Alternatively to this, the isolator assembly can have a telescopable spindle elevating drive for the axial or vertical repositioning of the rack. The spindle elevating drive can be configured very compactly together with a telescopable elevating column such as can be seen, for example, at www.spindelhubgetriebe.com of the company IFIA. An alternative to this can be a spiral lift, for example, from PACO (www.pacospiralift.com) which also has a small installation height in a retracted position and nevertheless enables a considerable lift. The telescopable lifting columns of both lifting devices can be inserted therein sealed in an airtight manner with respect to the atmosphere of the tent by means of a bellows, namely as an elastic “concertina-like” folding-together hose of rubber or plastic, so that the drive can remain completely outside the tent. The rotational movement of the rack which is optionally additionally to be sealed in the bellows can be accomplished by isolation techniques known per se in isolator construction, e.g. by sealing with the aid of silicone.

In principle, the devices for the rotational and the vertical translational movement of the rack can be arranged relative to the worktop according to two different principles relative to one another: the rotational device can be attached underneath the translational device so that the translational device follows the movement of the rotational device. Alternatively the rotational device can be arranged on the translational device so that said translational device need not follow a rotational movement but the rotational device also makes a translational movement. In both cases, the energy supply of that device which follows the movement of the other device is usually constructively more expensive. Advantageously the isolator assembly has a rotatable device for the axial repositioning of the rack relative to the stationary worktop. For this purpose, the lifting device can, for example, be arranged on a rotary disk which has its—mechanical, in particular muscle-operated or for example, electrical—drive outside the tent and can be set in rotation through a sterile and airtight feed-through in the tent. This arrangement requires, for example, an absolutely sealing lifting column in order to eliminate contaminations of the interior of the isolator due to the lifting device. Alternatively a flexible and hermetically sealed bellow can surround the lifting column or a scissors elevating drive. The bellows can thus form a part of the shell which also makes the translational movement of the lifting device and the rack. A rotation of the rack can enable a rotational seal of the bellows on a casing surface of the lifting device or the rack.

In principle, the tent or the shell of the isolator assembly can be formed in one part or one piece, which reduces the risk of complications and leaks. According to an advantageous embodiment of the isolator assembly however, the shell can have a multi-part structure from sections which can be coupled together. For this purpose, the sections can have coupling devices for airtight fastening to one another. Preferably the coupling devices can be configured detachable to enable damage-free dismantling of the shell, for example, for cleaning purposes. A simple coupling device is provided by a tongue and groove configuration on the mutually facing front sides of the sections. This forms a device which is easy to produce and assemble, which seals in a largely airtight manner. The remaining joints after coupling the sections can be sealed with silicone for safety or adhesively bonded over the entire area with a transparent film.

A multi-part shell furthermore offers the possibility of an expansion so that for example, if the rack is enlarged to accommodate additional containers, the rack can be adapted by inserting an expansion section. Thus, the technical and financial expenditure for a new shell can be dispensed with. Suitable sections of the shell according to the invention can, for example, consist in a bottom section, a section with gloved intervention points, a circular cylindrical section and a cover section. By omitting or inserting the circular cylindrical section or by inserting several circular cylindrical sections, the isolator assembly can be adapted to racks of different height at low expense. Also exchanging individual sections, for example, as a result of defects, can result in a particularly economical operating mode of the isolator assembly.

According to a further advantageous embodiment of the invention, the isolator assembly can have a control device for controlling the vertical and the rotational movement of the rack relative to the worktop and in particular for controlling the rotation of individual rack plates. The control device can alternatively or additional also be used to control processes with containers and/or work on objects in the containers and have a database for recording the objects and for documenting processes with and work on containers and/or their objects. This can be accompanied by a considerable facilitation of the operation of the isolator assembly per se and a documentation and avoidance of errors in the activities on the isolator assembly. A suitable control is specified in detail in WO 2011/124 209 A of the same applicant, the relevant content of which is also made the content of the present application.

According to a further advantageous embodiment of the invention, the isolator assembly can have identifications of the containers for the individualization thereof and corresponding reading devices. A suitable technology is described in WO 2014/053 436 A of the same applicant, the relevant content of which is also made the content of the present application. With a transparent shell, the possibility is afforded of arranging the reading devices outside the shell and allowing said reading devices to act therethrough so that the expenditure for their autoclaving before installation and any optionally necessary repair or maintenance can be omitted. Alternatively or additionally, the containers can be read automatically with so-called “cage talkers” or RFID equipped via NFC or RFID readers which are attached outside the shell and there for example in the centre underneath the worktop. This allows a software-side “automatic opening” of drawn containers in a control software as is basically described in WO 2011/124 209A.

With the aid of for example three cameras arranged around the rack or using two 3D cameras, it can be established from which compartment of the rack a container has been drawn. This information can be relayed to the control software, as described in detail in WO 2014/053 436 A. In addition, a camera fixed directly on the tent can, for example, observe the behaviour of animals in individual containers. Via the control software, the rack can be rotated at predefined intervals and raised and lowered to record on all the containers. Alternatively several cameras can be installed. A highly transparent tent allows the cameras to be mounted outside the tent.

An air lock device can be attached at largely any arbitrary and suitable position, for example, at the side of the tent. For operating purposes, namely for loading and unloading the air lock device, further gloved intervention points are required. According to a further advantageous embodiment of the invention, the isolator assembly can have an air lock device integrated in the worktop. For the arrangement of the air lock device the isolator assembly can leave free a foot space under the worktop, which approximately corresponds to the horizontal extension of the worktop and which can be used for safety containers which can be coupled to the air lock device. The safety containers can thus be coupled onto the isolator assembly from an underside of the worktop. Thus, a particularly compact structure can be achieved because the space under the worktop which projects with respect to the cylindrical rack can otherwise hardly be completely utilized. In addition, the air lock device thus lies in the direct access region of the gloved intervention points required in any case for operation of the worktop so that the air lock device can be conveniently actuated from the location of the user. The constructive expenditure and the space requirement for further gloved intervention points merely for operating the air lock device can thus advantageously be saved.

If the air lock device is not used, instead of the safety containers, dummy containers of smaller extension and merely for sealing purposes can be mounted. Then, the complete foot space can be available for the user of the isolator assembly.

According to a further advantageous embodiment of the invention, the air lock device can have two openings and a repositionable closure which only allows access to either the one or the other openings. With two openings the capacity of the air lock device can advantageously be doubled. Thus, twice the amount of material can be loaded or unloaded or loaded and unloaded in parallel. If however one of the two openings is to be used for loading and the other opening is to be used for unloading material contact of sterile and contaminated material can thus be reliably avoided. This is ensured by the repositionable closure which necessarily closes either the one or the other opening. This closure can be configured, for example, as a foldable cover, which forms a part of the worktop. Therefore if the cover closes one of the two openings, it serves as part of the worktop. Alternatively it can be arranged displaceably in the plane of the worktop in order to either release the one or the other opening but not both openings simultaneously.

Safety containers for accommodating a number of containers or loose material can be coupled in an airtight manner to the air lock device. The dimensions and the construction of these safety containers can be determined by the conditions of an autoclaving device in which these containers together with contents can be sterilized before they are coupled to the isolator assembly. According to a further advantageous embodiment of the invention, the safety containers and the air lock device can have a cooperating latching mechanism of the safety containers on the air lock device, which latching mechanism is coupled to the closure of the air lock device in such a manner that only an activated latching mechanism of a safety container on the air lock device allows an actuation of the closure. Such an air lock safety closure ensures that the sterile atmosphere in the isolator assembly is not adversely affected by an incorrect operation of a safety container when coupling to the air lock device.

According to a further advantageous embodiment of the invention, the isolator assembly can have a lifting device for containers in the safety container. In order to achieve an optimal usage of space, the safety containers can occupy the complete height from the ground to an underside of the worktop. In this way, the safety containers can accommodate a large number of containers one above the other. The lifting device helps the user to remove the containers from the safety containers with the movement space limited by the gloved intervention points and through one of the two openings in the worktop. To this end, then user needs to remove only the uppermost container in each case because the lifting device raises the containers located thereunder and thus raises these containers to a level approximately below the worktop and therefore into a region which can easily be reached by the user. It is thereby possible to appropriately use the large-volume safety containers below the worktop of the above-described air lock device. The lifting device can, for example, rest on spring force or on an air cushion under the containers, which the user of the isolator assembly connects to a compressed air source via a hose.

The worktop projects horizontally in front of the rack and therefore radially from the cylindrical rack. According to a further advantageous embodiment of the isolator assembly, the worktop can be configured so that it can be folded out or folded down out from its horizontal plane. If the worktop is in operation, it can release the space on the rack or on the isolator assembly otherwise occupied by said worktop so that the unused isolator assembly has a smaller space requirement. Said worktop can be folded completely towards the rack or only partially to the right or to the left onto itself. The folding of the worktop can be allowed by a flexible or removable section of the tent which comprises the gloved intervention points. As a result, it can be possible, for example, to arrange two isolator assemblies next to one another and with worktops pointing towards one another, wherein only one isolator assembly with folded-down worktop can be in operation. In this way, more isolator assemblies according to the invention can be accommodated in less space with the result that in particular these isolator assemblies can be used in smaller research facilities.

Work on or in an isolator assembly is made difficult by the gloved intervention points also with regard to the movement space. Any facilitation can contribute to a lower physical effort and to a lower error quota. According to a further advantageous embodiment of the isolator assembly, this can therefore have operating devices for operating a rack according to one of the above claims and/or for operating the control device of the isolator assembly according to claim 6 for users, in particular by keypad at a gloved intervention point and/or via voice recognition and/or by foot pedals. Details relating to these devices can be obtained from the application WO 2011/124 209 A, the relevant content of which is also made the content of the present application.

According to a further advantageous embodiment of the invention, the isolator assembly can have containers closed on all sides with microfilters on radially opposite container sides and a fan on the isolator for central extraction of air from the tent into the surrounding area. Slight negative pressure can prevail in the closed container since air is sucked through the cage via a fan. In order that the negative pressure in the container does not become too strong, a further fan can blow filtered air into the shell. By this means, the pressure in the container can be precisely set and regulated by simultaneously blowing and sucking. The contents of these containers, for example, animals in cages are then not only separated olfactorily, which eliminates interactions between the animals in different containers. Also a mutual contamination is eliminated, which is not necessarily the case in conventional animal isolators. In addition, the air is filtered twice, once when flowing into the shell and a further time when flowing into the container. By this means a high air quality and maximum hygiene for man and animals during husbandry can be particularly reliably ensured. Possible containers, for example, are tart-mould shaped containers such as those available from Animal Care Systems Inc. (www.animalcaresystems.com) or from Braintree Scientific, Inc. (www.braintreesci.com/prodinfo.asp?number=MPC).

The principle of the invention will be explained once again hereinafter with reference to the drawings. In the drawings:

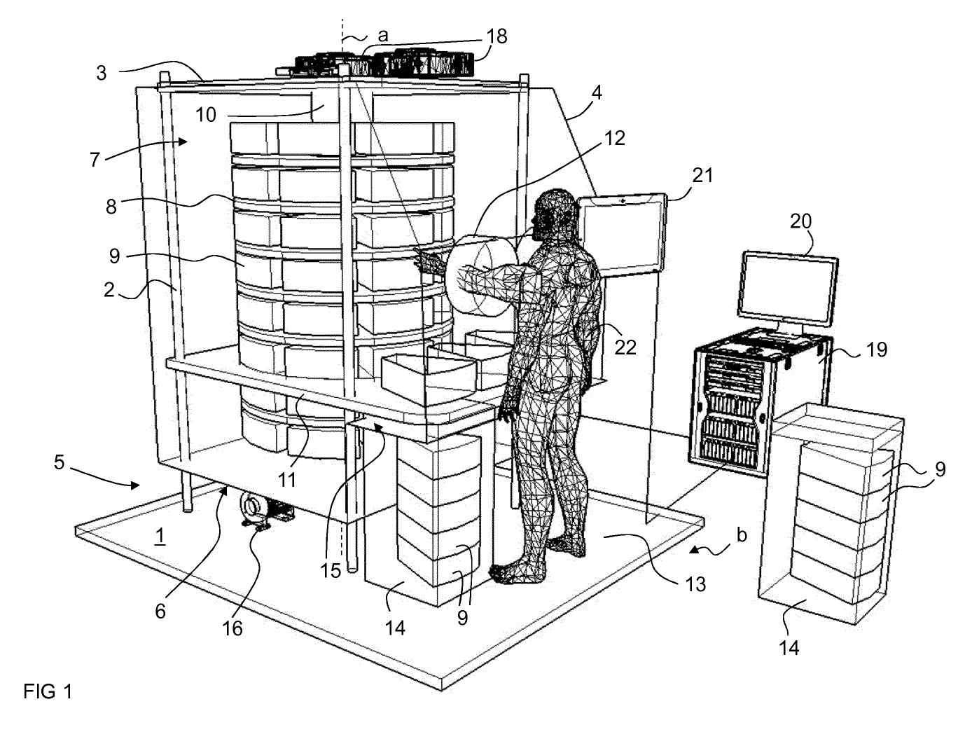

FIG. 1: shows a first perspective view of the isolator assembly,

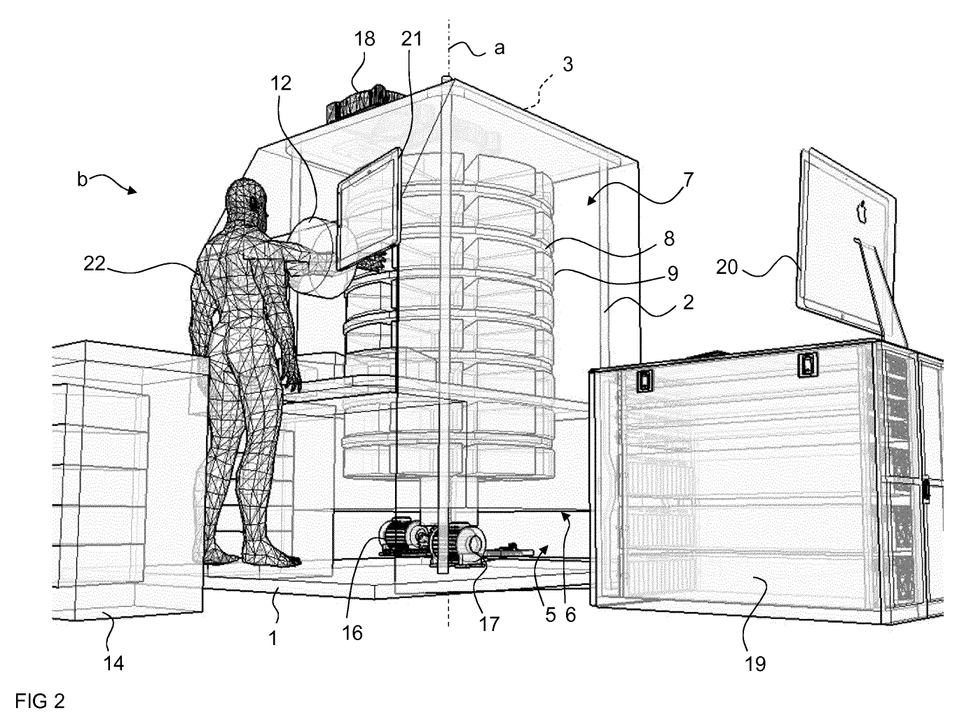

FIG. 2: shows a second perspective view of the same isolator assembly,

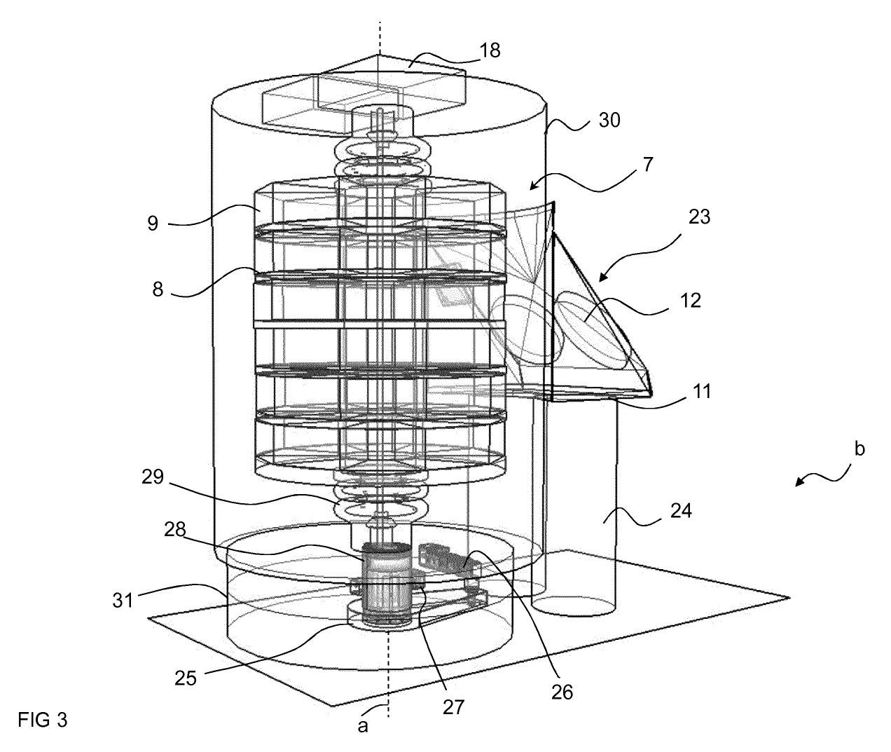

FIG. 3: shows a perspective view of a further embodiment of the isolator assembly,

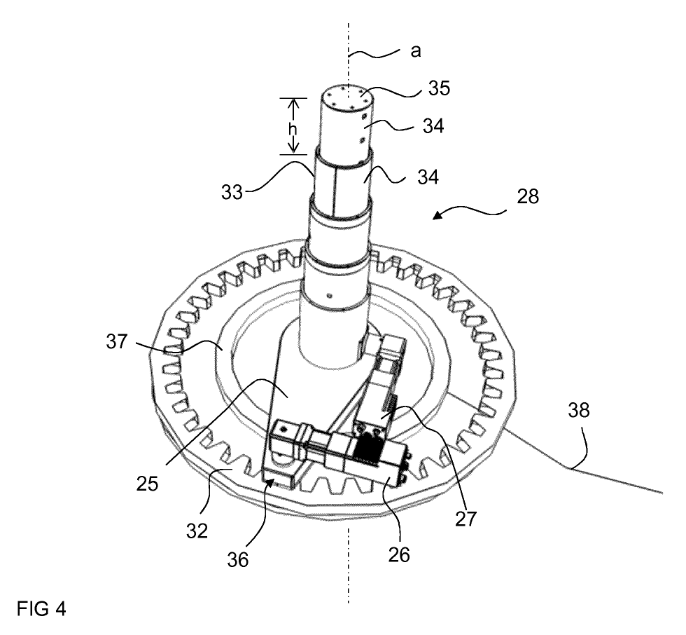

FIG. 4: shows a rotating and lifting device of the isolator assembly,

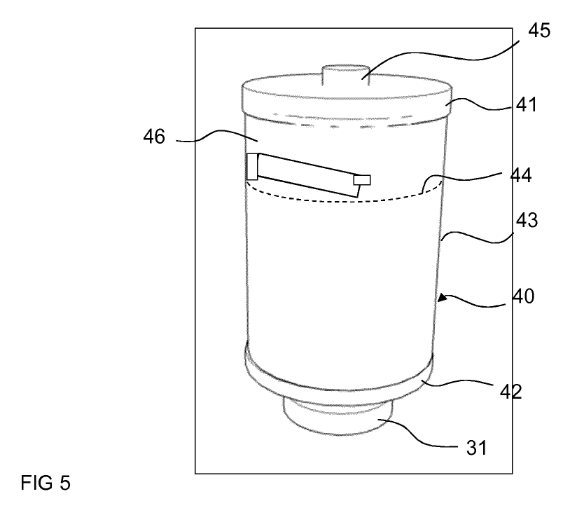

FIG. 5: shows a multipart shell of the isolator assembly and

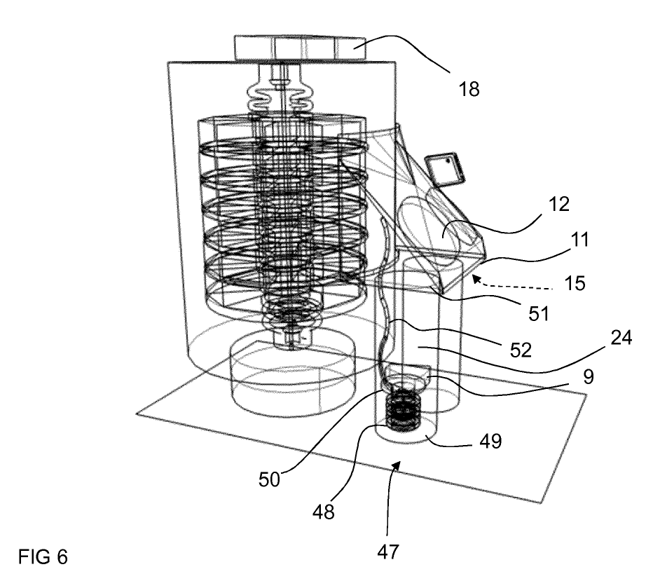

FIG. 6: shows a lifting device.

FIGS. 1 and 2 show perspective views of the same isolator assembly, in each case viewed from an operating side b. Four supports 2, which bear a cover plate 3 and a cubic transparent shell 4, rise up from a foot plate 1. The shell 4 does not reach down completely to the foot plate 4 but leaves free an intermediate space 5 between its underside 6 and the foot plate 1. In its interior, the shell 4 accommodates a cylindrical rack 7 with a vertical axis a, which rack each accommodates ten circular-sector shaped cages 9 on eight disk-shaped rack plates 8. The rack plates 8 are carried by a central centre column 10 on the vertical axis a of the rack 7. The centre column 10 is hollow and is rotatable and also displaceable vertically along the vertical axis a.

Alternatively, a hollow centre column can be formed in each case of axial tube sections on the rack plates approximately at the height of a cage. The tube sections can be configured to be conical at least in sections so that they can be placed inside one another in a frictionally connected manner. The tube sections can additionally contain air connections for the ventilation or aeration of the cages. If the rack plates are additionally rotatably coupled amongst one another, they can be twisted independently of one another and a single rack plate can be twisted independently of the rest of the rack.

The supports 2 inside the shell 4 also bear a worktop 11 which projects on one side on the user side b of the isolator assembly. This worktop is slightly wider than the diameter of the cylindrical rack 7 and affords a working space of at least the depth of a cage 9. Three cages 9 can be conveniently placed on said worktop and can be manipulated thereon and inside the shell 4. For this purpose, the shell 4 has two gloved intervention points 12 above the worktop 11, which provide access inside the shell 4 to the cages 9 facing the gloved intervention points 12 in the rack 7 and on the worktop 11.

Under the worktop 11 the shell 4 is set back in the direction of the rack 7 and thereby exposes a foot space 13. This foot space extends under the overhang of the worktop 11 and thus extends from its front edge facing the user 22 as far as the first two supports 2 in front of the cylindrical rack 7. Cubic safety containers 14 can be inserted into the foot space 13 and coupled in an airtight manner to an air lock device 15, not shown in detail, from below on the worktop 11. The safety containers 14 can accommodate five cages 9 and can be sterilized together with their contents. Via the air lock device 15, the cages can be actuated through the opened, for example, partially unfolded or pushed-on worktop 11, namely removed and placed on the remaining worktop 11. In order that the safety containers 14 can be operated and reached from the gloved intervention points 12, the safety containers 14 have a lifting device shown in FIG. 6 for lifting the cages 9 approximately to the level of the worktop 11.

In order that the cages 9 of the uppermost and the lowermost rack plates 8 and the rearmost cages 9 when viewed by the user 22 can also be reached from the gloved intervention points 12, the rack plates 8 and with them the cylindrical rack 7 can be twisted and moved vertically. For this purpose the isolator assembly has a lifting motor 16 and a turning motor 17 in the intermediate space 17 (FIG. 2). These motors are arranged outside the shell 4 and therefore cannot adversely affect the sterile and germ-free atmosphere inside the shell 4. In addition, these motors can easily be reached for maintenance and repair work without the interior of the shell 4 being adversely affected thereby.

A first and a second fan 18 are arranged on the upper side of the isolator assembly and there on the cover plate 3, which fans blow in air into the shell 4 via a filter and extract it again through the hollow centre column 10. The fans 18 allow the pressure in the cages 9 to be regulated precisely. This is because the cages 9 are configured to be closed and have a cover (not shown) as well as respectively one air passage (not shown) with a microfilter on their curved front side facing the user 22 and on their narrow rear side facing the centre column 10. As soon as the centre column 10 extracts air via the first fan 18. a negative pressure is formed in the cage 9. It can be regulated by the second fan blowing filtered air into the shell 4. Thus, the pressure in the cages 9 can be regulated precisely by blowing and sucking. In addition, animals in the covered cages 9 are separated olfactorily, which is not usually the case in conventional animal isolators. Finally the air is filtered several times: the first time when flowing into the shell 4 and a further time when flowing into the cages 9. Even the possibly contaminated air from the cages 9 is filtered on exit from the cages 9 through a microfilter on the rear side thereof. Thus, high hygiene requirements can also be satisfied for protection of the operator 22 of the isolator assembly.

Depending on the application of the isolators, they can be operated at positive or negative pressure, in the case of infectious diseases usually at negative pressure to protect the user 22, in the case of gnotobiotic application at positive pressure to protect the animal. Positive pressure and negative pressure can be set by a corresponding activation of the fans 18. In addition, by activating the fans 18 the air flow through the cages 9 can also be reversed. To this end air is blown into the cages 9 through the centre column 10 and extracted from there via the remaining interior of the shell 4.

The isolator assembly additionally has a computer 19 with a screen 20 on which there is contained a control device for the and possibly further (not shown) isolator assemblies and a database with data relating to the content of the cages 9 and possibly further cages. For a more rapid access or view of the computer 19, the isolator assembly additionally has a screen 21 on the outside on the right next to the gloved intervention points 12, which screen is touch-sensitive (touchscreen). In addition, the user 22 wears a small touchscreen or keypad clipped to the underarm (not shown) which he can actuate through the gloved intervention points 12 during work on the cages 9 without needing to pull off the gloved intervention points 12.

The user 22 of the isolator assembly can firstly inspect the database relating to the cage contents on the computer 19, register on the screen 21 as a user and the like. He performs activities in the isolator assembly by actuating the gloved intervention points 12. Now he can perform work on the cages 9 or their contents inside the shell 4 and carry out activities. To this end he can place individual cages 9 on the worktop 11 and process them. Since the gloved intervention points 12 only allow a restricted movement and the cages 9 of the upper and the lower rack plates 8 cannot be reached without assistance, the user 22 can turn and raise and lower the rack in a motor-driven manner by controlling the foot pedal or by input on the keypad. Thus, each cage 9 can be brought into the range of the gloved intervention points 12.

New cages 9 or new material enter into the isolator assembly via the safety containers 14. After coupling onto the air lock device 15, fresh cages 9 from the safety container 14 can be placed on the worktop 11 optionally by means of the lifting device and further processed there. Contaminated material or contaminated cages 9 can be unloaded conversely via the second safety container 14. On the screen 21 or—without interrupting his work—on the keypad, the user 22 can register his procedures and work and/or record proposed and implemented procedures and work, whereupon the datasets in the database are updated.

FIG. 3 shows a further embodiment of an isolator assembly according to the invention. This isolator assembly has a fundamentally comparable structure to those of FIGS. 1 and 2, namely comprising a cylindrical rack 7 which comprises six rack plates 8 each having eight cages 9. The cylindrical rack 7 is surrounded by a cylindrical shell 30, a worktop 11 projecting on the user side b of the shell 30. In a triangular working area above the worktop 11 in a side view, two gloved intervention points 12 are accommodated. Under the worktop 11 cylindrical safety containers 24 can be latched in the manner described above and actuated. On its upper side the isolator assembly has two fans 18 which supply fresh air to the interior of the cylindrical shell 30 and the cages 9 in the manner described above and extract used air.

A difference is that the isolator assembly of FIG. 3 has a cylindrical and removal supporting ring 31 having a somewhat smaller diameter than the shell 30. The shell 30 rests on this supporting ring. The supporting ring 31 surrounds a rotational leg 25 which is driven by a rotary motor 26 and which is set in rotation in the manner explained in detail in FIG. 4. Located on the rotational leg 25 is a partially concealed lifting motor 27 which also performs a twisting of the rotational leg 25 via the rotary motor 26. The lifting motor 27 has a spindle lifting mechanism 28 which moves the rack 7 upwards and downwards along a vertical axis. Both the lifting motor 27 and also the spindle lifting mechanism 28 are arranged outside the stationary shell 30. Whereas the lifting motor 27 is positioned underneath the shell 30, the spindle lifting mechanism 28 ensheathed by a bellows 29 projects into the shell 30. The bellows 29 is a quasi-vertically deformable but rotationally fixed section of the stationary cylindrical shell 30 which creates an airtight transition between the interior of the shell 30 and the rotational and lifting forces acting from outside on the ensheathed cylindrical rack 7. Thus, on the one hand the contents of the cylindrical shell 30 and in particular the cylindrical rack 7 remain sealed in an airtight and sterile manner with respect to the surroundings. On the other hand , the lifting motor 27 and the rotary motor 26 can be maintained and optionally repaired from an outer side of the cylindrical shell 30 without adversely affecting the hygiene conditions inside the cylindrical shell 30.

FIG. 4 shows the vertical and rotational drive of the rack 7 in detail: the rotary motor 26 and the lifting motor 27 sit together on the rotational leg 25. The rotational leg rotates about the vertical axis a and extends radially as far as an internally toothed sprocket 32, which is arranged coaxially to the vertical axis a. The spindle lifting mechanism 28 is also mounted coaxially on the rotational leg 25, which mechanism can be driven by the lifting motor 27. This comprises a telescopable lifting rod 33 comprising five cylindrical segments 34 having the height h. The lifting rod 33 can thus be extended to approximately five times the height h of a segment 34. Located at the top end of the lifting rod 33 is a rotatable disk 35 as part of rotary seal of the stationary bellows 29 (FIG. 3) not shown with respect to the rotatable rack 7. The disk 35 can be twisted with respect to the bellows 29 but hermetically seals the atmosphere inside the shell 30 (FIG. 3) with respect to the surrounding area.

The rotational leg 25 engages in the sprocket 32 at its radially outer end 36 via a concealed toothed wheel. The rotary motor 26 drives the toothed wheel and sets in rotation the rotational leg 25 and with this itself, the lifting motor 27 and the spindle lifting mechanism 28. The rotational leg 25 thereby sweeps a coaxial sliding ring 37 which cooperates with siding contacts arranged in a concealed manner on an underside of the rotational leg 25. The sliding ring 37 is connected via a power line 38 to a conventional power source and supplies energy both to the rotary motor 26 and also to the lifting motor 27.

This therefore results in a drive for the vertical and the rotational movement of the rack 7 which requires an extremely small installation height and therefore can be advantageously placed under the rack 7 without it taking up storage space which can be used for cages 9. At the same time, the motors 26, 27 can be arranged outside the shell 30 (FIG. 3) with the result that they are easily accessible for maintenance and repair work and the atmosphere inside the shell 30 is neither adversely influenced thereby nor by its operation as intended.

FIG. 5 shows a schematic reproduction of a multipart cylindrical shell 40. This shell is composed of a plate-shaped cover 41, an identical base 42, and a transparent cylinder casing 43, which can be divided into individual casing sections 46 by intermediate rings 44 in the vertical direction. The cover 41 has a collar-shaped shoulder 45 as a connection to the fans 18 (FIG. 3). The base 42 supports the shell 40 on the supporting ring 31 (FIG. 3). The intermediate rings 44 allow the casing 43 to be broken down into several casing sections 46 so that the shell 40, for example, can be adapted to a changed height of the rack 7. In addition, these intermediate rings make it possible to exchange damaged casing sections 46 without the casing 43 needing to be completely replaced. Finally the height of the gloved intervention points 12 (see FIG. 3) which are mounted on a special casing section not shown can be adapted to changed conditions by inserting or removing individual casing sections 46. A sealing of various casing sections 46 can be achieved by sticking over the joins between the casing sections 46 and the intermediate rings 45 with transparent adhesive tape.

In addition to the isolator assembly shown in FIG. 3, FIG. 6 shows a lifting device 47 not shown there in the safety containers 24. This lifting device comprises a bellows-like cylindrical air cushion 48 which can be expanded by inflating, which rests on a container base 49 of the safety container 24. The air cushion 48 carries a disk-shaped plate 50 on which a cage 9 is placed. An air hose 52 runs through the plate 50 and out via an upper side 51 of the safety container 24, which air hose can be connected via couplings and valves not shown to an air line from the fan 18 as compressed air source, also not shown.

As soon as the safety container 24 is coupled under the worktop 11 to the air lock device 25 there in an airtight manner, the user 22 (FIGS. 1 to 3) can open the safety container 24. If it is completely filled, the user can remove an uppermost cage 9. If only one cage 9 is located therein however, his scope for movement in the gloved intervention points 12 is not sufficient to grip right into the safety container 24. He thus connects the air hose 52 provided in the safety container 24 in the area of its upper side 51 to the fans 18 as compressed air source. These fans then expand the air cushion 48 which lifts the cage 9 vertically until the user 22 can remove it.

### REFERENCE LIST

1 Foot plate
2 Support
3 Cover plate
4 Shell
5 Intermediate space
6 Underside
7 Cylindrical rack
8 Rack plate
9 Cage
10 Centre column
11 Worktop
12 Gloved intervention point
13 Foot space
14 Safety container
15 Air lock device
16 Lifting motor
17 Rotary motor
18 Fan
19 Computer
20 Screen
21 Screen (Touchscreen)
22 User
23 Working area
24 Safety container
25 Rotational leg
26 Rotary motor
27 Lifting motor
28 Spindle elevating mechanism
29 Bellows
30 Cylindrical shell
31 Supporting ring
32 Sprocket
33 Lifting rod
34 Segment
35 Disk
36 Outer end
37 Sliding ring
38 Power line
40 Shell
41 Cover
42 Bottom
43 Casing
44 Intermediate ring
45 Shoulder
46 Casing section
47 Lifting device
48 Air cushion
49 Bottom of safety container 24
50 Plate
51 Top of safety container 24
52 Air hose
a Vertical axis
b User side
h Height of a segment 34

1. Isolator assembly for producing and maintaining a sterile environment, in particular for plant cultivation or animal research or preparation of medicaments comprising
a cylindrical rack with a vertical axis,
containers (cages) (each for accommodating at least one object as the contents thereof) arranged circumferentially in the rack (and accessible in a radial direction),
a worktop in the immediate vicinity of the rack with a foot region situated underneath/in front of the worktop,
a tent for the joint sterile shielding of both the rack and at the same time the worktop with respect to the surrounding area,
with gloved intervention points in the tent for operating and/or processing the containers and/or the contents thereof between the rack and the worktop,
an air lock device in the tent for introducing sterile material into the tent and for removing contaminated material from the tent,
(in each case) a device for repositioning the rack relative to the worktop in an axial direction and in a rotational direction.

2. The isolator assembly according to claim 1, characterized by (in each case) a motor drive for repositioning the rack relative to the worktop preferably outside the tent.

3. The isolator assembly according to claim 1, characterized in that the rack comprises individual horizontally running disk-shaped plates on which the containers can be placed.

4. The isolator assembly according to claim 1, characterized by a spindle elevating drive or a scissors elevating drive as the device for axial repositioning.

5. The isolator assembly according to claim 1, characterized by a rotatable device for the axial repositioning of the rack relative to the worktop.

6. The isolator assembly according to claim 1, characterized by a multi-part structure of the tent from sections which can be coupled together.

7. The isolator assembly according to claim 1, characterized by a control device for controlling the movements of the rack and/or for controlling processes with containers and/or work on objects in the containers and a database for recording the objects and for documenting processes with and work on containers and/or their objects.

8. The isolator assembly according to claim 1, characterized by identification devices of the containers for the individualization thereof and by corresponding reading devices on the isolator assembly.

9. The isolator assembly according to claim 1, characterized by an air lock device integrated in the worktop.

10. The isolator assembly according to claim 9, characterized by two openings in the worktop and a repositionable closure which allows access to either the one or the other openings.

11. The isolator assembly according to claim 10, characterized by a latching mechanism of the safety container on the air lock device and by a coupling of the latching mechanism to the closure of the air lock device so that only an activated latching mechanism allows an actuation of the closure.

12. The isolator assembly according to claim 11, characterized by a lifting device for cages in the safety container.

13. The isolator assembly according to claim 1, characterized in that the worktop is configured so that it can be folded out or folded down out from a horizontal plane.

14. Isolator assembly, characterized by operating devices for operating a rack according to claim 1 for users by keypad at a gloved intervention point and/or via voice recognition and/or by foot pedals.

15. The isolator assembly according to claim 1, characterized by containers closed on all sides with microfilters on radially opposite container sides and a fan for central extraction of air from the tent into the surrounding area.

16. Isolator assembly, characterized by operating devices for operating the control device of the isolator assembly according to claim 7 for users by keypad at a gloved intervention point and/or via voice recognition and/or by foot pedals.
